(19) United States
(12) Patent Application Publication
(10) Pub. No.: US 2024/0063434 A1
(43) Pub. Date: Feb. 22, 2024

(54) ELECTROLYTE COMPATIBLE LITHIUM-ION BATTERY ANODE

(71) Applicant: FORD GLOBAL TECHNOLOGIES, LLC, Dearborn, MI (US)

(72) Inventors: Feng LI, Troy, MI (US); Andrew TIPTON, Dearborn, MI (US); Chi PAIK, Grosse Ile, MI (US)

(21) Appl. No.: 17/892,817

(22) Filed: Aug. 22, 2022

(51) Int. Cl. H01M 10/0567; H01M 10/0525; H01M 10/0569

(52) U.S. Cl. CPC H01M 10/0567; H01M 10/0525; H01M 10/0569; H01M 2300/0042; H01M 2300/0051; H01M 2300/0091

(57) ABSTRACT

A method for forming a solid electrolyte interface on a lithium-ion battery electrode is provided. The method includes a step of introducing a first quantity of a first electrolyte composition into a container. The container includes at least one lithium-ion battery cell and the first electrolyte composition including ethylene carbonate. The lithium-ion battery cell is cycled for at least one charging cycle such that one or more solid electrolyte interfaces are formed. A second electrolyte composition is introduced into the container to form a final electrolyte composition, the second electrolyte composition including propylene carbonate.

### TECHNICAL FIELD

In at least one aspect, a method for utilizing propylene carbonate in a lithium-ion battery is provided.

### BACKGROUND

Diverse electrolyte usage offers numerous advantages for lithium-ion battery cells including low temperature and high power performances. High dielectric constant solvents can be used to dissolve lithium salts. Two common non-aqueous solvents are ethylene carbonate (solid at room temperature) and propylene carbonate (a liquid at room temperature). However, when a lithium-ion battery is assembled with graphite anodes, ethylene carbonate is used due to incompatibility between liquid propylene carbonate and graphite. Propylene carbonate leads to sustained undesirable side reactions that inhibit lithium ion intercalation. Propylene carbonate offers opportunities, such as effective low-temperature performance.

Accordingly, there is a need for methods that would allow propylene carbonate to be used in the electrolyte for lithium-ion batteries.

### SUMMARY

In at least one aspect, a method for forming a solid electrolyte interface on a lithium-ion battery electrode is provided. The method includes a step of introducing a first quantity of a first electrolyte composition into a container. The container includes at least one lithium-ion battery cell and the first electrolyte composition including ethylene carbonate. The lithium-ion battery cell is cycled for at least one charging cycle such that one or more solid electrolyte interfaces are formed. A second electrolyte composition is introduced into the container to form a final electrolyte composition, the second electrolyte composition including propylene carbonate.

In another aspect, a two-step solution of pre-forming a lithium-ion battery cell allows a robust growth of the solid electrolyte interface (SEI). The formed battery cells are robust to incompatible chemistries associated with propylene carbonate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic side view of a pouch containing one or more lithium-ion battery cells.

FIG. 1B. Schematic front view of a pouch containing one or more lithium-ion battery cells.

FIG. 2. Schematic flowchart of a method for pre-forming solid electrolyte interfaces on the electrodes of a lithium-ion battery.

FIG. 3A. Schematic cross-section of a negative electrode having a pre-formed solid electrolyte interface.

FIG. 3B. Schematic cross-section of a negative electrode having a pre-formed solid electrolyte interface.

FIG. 4A. Schematic cross-section of a positive electrode having a pre-formed solid electrolyte interface.

FIG. 4B. Schematic cross-section of a positive electrode having a pre-formed solid electrolyte interface.

FIG. 5. Schematic cross-section of a lithium-ion battery cell including the electrodes of FIG. 3A and FIG. 4A.

FIG. 6. Schematic cross-section of a lithium-ion battery pack including the lithium-ion battery cell of FIG. 5.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean“only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “positive electrode” means a battery cell electrode from which current flows out when the lithium-ion battery cell or battery is discharged. Sometimes a “positive electrode” is referred to as a “cathode.”

The term “negative electrode” means a battery cell electrode to which current flows in when the lithium-ion battery cell is discharged. Sometimes a “negative electrode” is referred to as an “anode.”

The term “cell” or “battery cell” means an electrochemical cell made of at least one positive electrode, at least one negative electrode, an electrolyte, and a separator membrane.

The term “battery” or “battery pack” means an electric storage device made of at least one battery cell. In a refinement, “battery” or “battery pack” is an electric storage device made of a plurality of battery cells.

### Abbreviations

“BEV” means battery electric vehicle.
“LCO” means lithium cobalt oxide. “NCM” means lithium nickel cobalt manganese oxide.
“NCM” means lithium nickel cobalt manganese oxide.
“NCMA” means lithium nickel cobalt manganese aluminum oxide.
“NCA” means lithium nickel cobalt aluminum oxide.
“LFP” means lithium iron phosphate.
“LMP” means lithium manganese phosphate.
“LVP” means lithium vanadium phosphate.
“LMO” means lithium manganese oxide.
“SEI” means solid electrolyte interface.

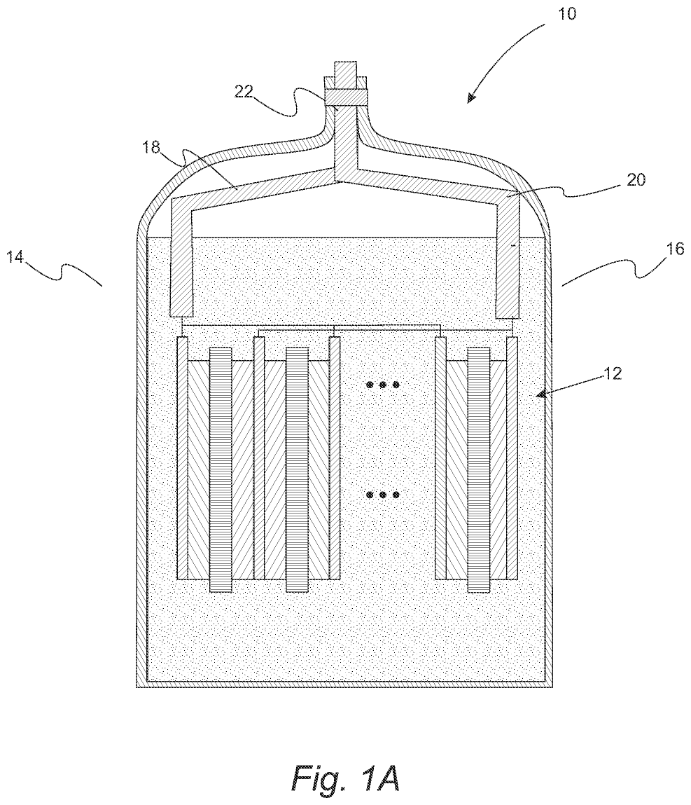

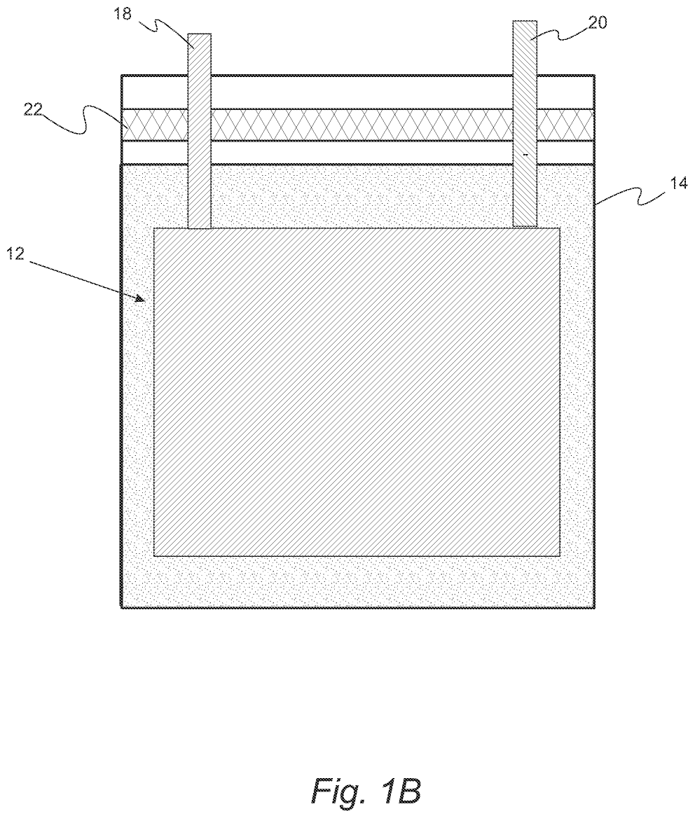

Lithium-ion battery cells are typically placed in a sealed container such as a laminated pouch or a metal can. FIGS. 1A and 1B depict such a sealed pouch. Package lithium-ion battery system 10 includes a lithium-ion battery cell or battery 12 positioned in pouch 14. Pouch 14 can be made from an aluminum-plastic laminate. The pouch also contains an electrolyte 16 as described below in more detail. The electrolyte comprises a solution containing a lithium salt. Terminals 18 and 20 protrude from the container allowing electrical contact thereto. Typically, pouch 14 is sealed along seal line 22.

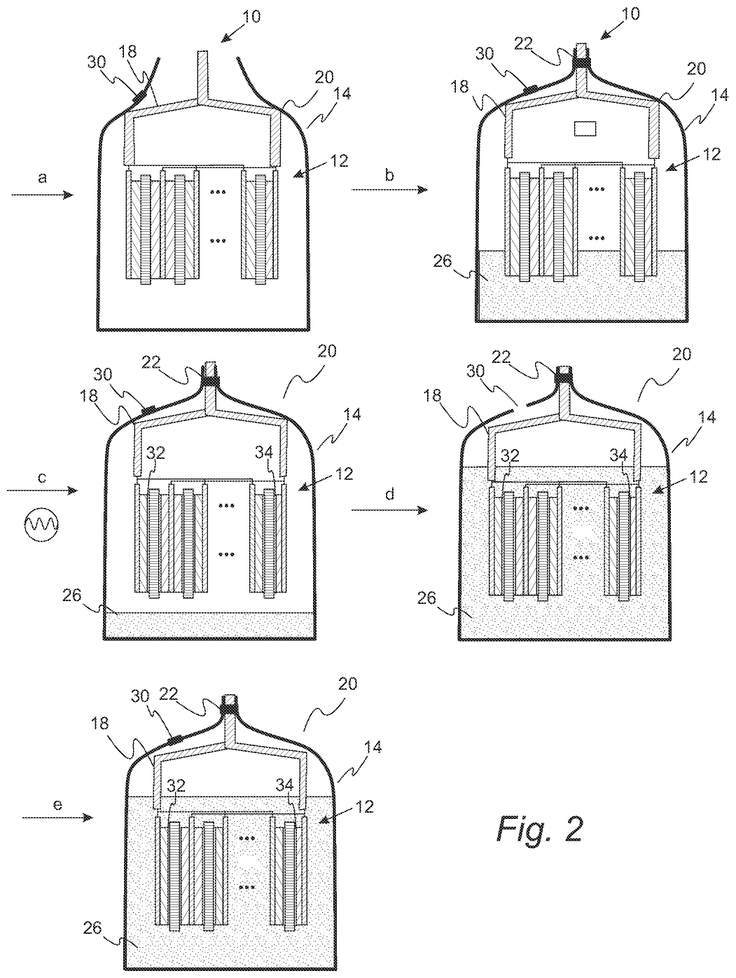

Referring to FIG. 2, a schematic flow chart of a method for pre-forming solid electrolyte interfaces in a packaged battery cell is provided. In step a), a package assembly 10 that includes one or more battery cells 12 packaged in container 14 is provided. Typically, package assembly 10 has not been sealed at this point. Container 14 can be a laminated pouch or a metal can as is known in the art. FIG. 2 depicts a pouch but the method is equally applicable to a prismatic cell. In step b), a first quantity of a first electrolyte composition 26 is introduced into container 14 and then the pouch is sealed. In a refinement, a lithium salt is dissolved in the first electrolyte composition. Characteristically, the first electrolyte composition includes ethylene carbonate. In step c), the lithium-ion battery cell is cycled for at least one charging cycle such that one or more solid electrolyte interfaces 32, 34 are formed. In a refinement, solid electrolyte interface 32 forms over the positive electrode and solid electrolyte interfaces forms over the negative electrode. A solid electrolyte interface can form over the negative electrode and/or the positive electrode. In step d), a second electrolyte composition is introduced into the container to form a final electrolyte composition. In a refinement, seal 30 can be removed or punctured to allow the introduction (e.g., injection) of the second electrolyte composition. In a refinement, a lithium salt is dissolved in the second electrolyte composition. Advantageously, the second electrolyte composition includes propylene carbonate. In a refinement, the lithium-ion battery cell is degassed prior to introducing the second electrolyte composition. In step e), container 14 is resealed.

In a variation, the final electrolyte composition includes from about 20 to 99 weight percent of propylene carbonate of the total weight of the final electrolyte composition. In a refinement, the final electrolyte composition includes from about 50 to 99 weight percent of propylene carbonate the total weight of the final electrolyte composition. In some variations, the final electrolyte composition includes at least 20, 30, 40, 50, 60, or 70 weight percent propylene carbonate of the total weight of the final electrolyte composition and at most 99.5, 99, 95, 90, 85, or 80 weight percent propylene carbonate of the total weight of the final electrolyte composition. The final electrolyte composition includes from about 1 to 80 weight percent ethylene carbonate of the total weight of the final electrolyte composition. In a refinement, the final electrolyte composition includes from about 1 to 50 weight percent of ethylene carbonate of the total weight of the final electrolyte composition. In some variations, the final electrolyte composition includes at least 0.5, 1, 5, 10, 20, or 30 weight percent ethylene carbonate of the total weight of the final electrolyte composition and at most 85, 80, 70, 60, 50, or 40 weight percent ethylene carbonate of the total weight of the final electrolyte composition.

At set forth above, the lithium-ion battery cell is cycled for at least one cycle prior to introducing the second electrolyte composition. In a refinement, the lithium-ion battery cell is cycled for a plurality of cycles prior to introducing the second electrolyte composition. For example, the lithium-ion battery cell can be cycled for at least 2 cycles prior to introducing the second electrolyte composition. In a refinement, the lithium-ion battery cell can be cycled for at least 2, 3, 5, 10, 20, 50, 100, 500, or 1000 cycles prior to introducing the second electrolyte composition. The cycling for each battery cell can be performed at any suitable voltage and charging rate. For example, a charging cycle for each battery cell can be performed at a voltage up to 6.0 V with a charge rate of C/20 or higher.

In some variations, the first electrolyte composition and/or the second electrolyte composition can include a passivating additive. In a refinement, the passivating additive is a vinyl carbonate such as vinylene carbonate (VC), vinyl ethylene carbonate (VEC), or a sulfone.

As set forth below, the lithium-ion battery lithium-ion battery can include a negative electrode that includes a graphite layer. Advantageously, a solid electrolyte interface forms on the negative electrode thereby protecting the graphite layer from propylene carbonate co-intercalation.

The first electrolyte composition and the second electrolyte composition can each include additional non-aqueous solvents. For example, the first electrolyte composition can further include a first additional solvent selected from the group consisting of dimethyl carbonate, diethyl carbonate, dipropyl carbonate, methylpropyl carbonate, ethylpropyl carbonate, ethylmethyl carbonate, butylene carbonate, and combinations thereof. Typically, the first additional solvent is present in an amount less than an amount of the ethylene carbonate. Similarly, the second electrolyte composition can further include a second additional solvent selected from the group consisting of includes dimethyl carbonate, diethyl carbonate, dipropyl carbonate, methylpropyl carbonate, ethylpropyl carbonate, ethylmethyl carbonate, butylene carbonate, and combinations thereof. Typically, the second additional solvent is present in an amount less than an amount of the propylene carbonate.

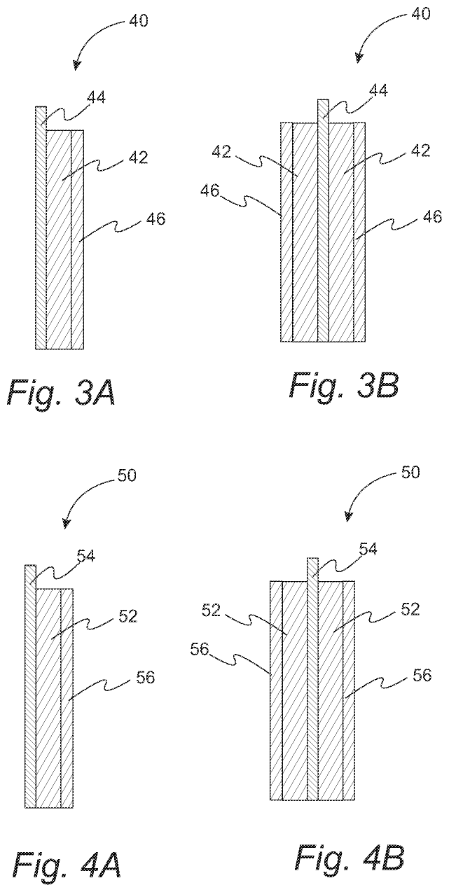

With references to FIGS. 3A and 3B, schematics of a negative electrode that includes a solid electrolyte interface formed by the method of FIG. 2 are provided. The negative electrode 40 includes a negative electrode active material layer 42 of negative electrode active material disposed over and typically contacting negative electrode current collector 44. FIG. 3A depicts a variation in which a single side of current collector 44 is coated with negative electrode active material layer 42 while FIG. 3B depicts a variation in which two sides of current collector 44 are coated with negative electrode active material layer 42. Typically, the negative electrode active material includes graphite. The negative electrode current collector 44 is a metal plate or metal foil composed of a metal such as aluminum, copper, platinum, zinc, titanium, and the like. Currently, copper is most commonly used for the negative electrode current collector. Solid electrolyte interface 46 is disposed over negative electrode active material layer 42. Solid electrolyte interface 46 is formed by the method of FIG. 2. Advantageously, Solid electrolyte interface 46 allows intercalation of lithium ions into the negative electrode active layer 42.

With references to FIGS. 4A and 4B, schematics of a positive electrode that includes one or more solid electrolyte interfaces formed by the method of FIG. 2 are provided. The positive electrode 50 includes a positive electrode active material layer 52 of positive electrode active material disposed over and typically contacting positive electrode current collector 54. FIG. 4A depicts a variation in which a single side of current collector 54 is coated with positive electrode active material layer 52 while FIG. 3B depicts a variation in which two sides of current collector 54 are coated with positive electrode active material layer 52. The positive electrode active material can be any material know in the art that is used as a positive electrode material for lithium-ion batteries. Typically, positive electrode current collector 54 is a metal plate or metal foil composed of a metal such as aluminum, copper, platinum, zinc, titanium, and the like. Currently, aluminum is most commonly used for the positive electrode current collector. Solid electrolyte interface 56 is disposed over negative electrode active material layer 52. Advantageously, solid electrolyte interface 56 is formed by the method of FIG. 2.

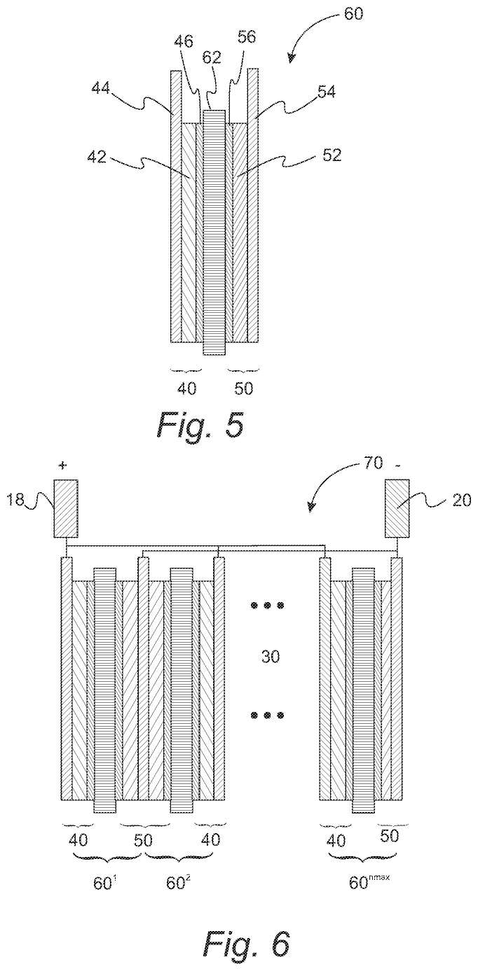

With reference to FIG. 5, schematics of a rechargeable lithium-ion battery cell incorporating the negative electrode of FIGS. 3A-B and the positive electrode of FIGS. 4A-B are provided. Battery cell 60 includes negative electrode 40, positive electrode 50, and separator 62 interposed between the positive electrode and the negative electrode. Negative electrode 40 includes a negative electrode current collector 44 and positive electrode active material 42 disposed over the negative electrode current collector. Solid electrolyte interface 46 is disposed over negative electrode active material layer 42. Positive electrode 50 includes a positive electrode current collector 54, positive electrode active material 52 disposed over the positive electrode current collector. Solid electrolyte interface 56 is disposed over negative electrode active material layer 52.

With reference to FIG. 6, a schematic of a rechargeable lithium-ion battery pack incorporating negative electrode of FIGS. 3A-B, the positive electrode of FIGS. 4A-B, and the battery cells of FIG. 5 is provided. Rechargeable lithium-ion battery 70 includes at least one battery cell of the design in FIG. 5. Typically, rechargeable lithium-ion battery 70 includes a plurality of battery cells 60ⁱ of the design of FIG. 5 where i is an integer label for each battery cell. The label i runs from 1 to nmax, where nmax is the total number of battery cells in rechargeable lithium-ion battery 70. Details for the battery cells are set forth above

Referring to FIGS. 5 and 6, separator 62 physically separates the negative electrode 40 from the positive electrode 50 thereby preventing shorting while allowing the transport of lithium ions for charging and discharging. Therefore, separator 62 can be composed of any material suitable for this purpose. Examples of suitable materials from which separator 63 can be composed include but are not limited to, polytetrafluoroethylene (e.g., TEFLON®), glass fiber, polyester, polyethylene, polypropylene, and combinations thereof. Separator 62 can be in the form of either a woven or non-woven fabric. Separator 62 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

As set forth above, the first electrolyte composition, the second electrolyte composition, and the final electrode composition can include a lithium salt dissolved therein. Therefore, lithium ions can intercalate into the positive electrode active material during charging and into the anode active material during discharging. Examples of lithium salts include but are not limited to LiPF₆, LiBF₄, LiSbF₆, LiAsF₆, LiC₄F₉SO₃, LiClO₄, LiAlO₂, LiAlCl₄, LiCl, LiI, LiN(SO₂CF₃)₂, LiN(SO₂F)₂, and combinations thereof. In a refinement, the first electrolyte composition, the second electrolyte composition, and the final electrode composition independently include the lithium salt in a concentration from about 0.1 M to about 2.0 M.

Referring to FIGS. 3, 4, 5, and 6, the negative electrode and the positive electrode can be fabricated by methods known to those skilled in the art of lithium-ion batteries. Typically, an active material (e.g., the positive or negative active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 3, 4, 5, and 6, the positive electrode active material layer 52 includes positive electrode active material, a binder, and a conductive material. The positive electrode active materials used herein can be those positive electrode materials known to one skilled in the art of lithium-ion batteries. In particular, the positive electrode 54 may be formed from a lithium-based active material that can sufficiently undergo lithium intercalation and deintercalation. The positive electrode 32 active materials may include one or more transition metals, such as manganese (Mn), nickel (Ni), cobalt (Co), chromium (Cr), iron (Fe), vanadium (V), and combinations thereof. Common classes of positive electrode active materials include lithium transition metal oxides with layered structure and lithium transition metal oxides with spinel phase. Examples of lithium transition metal oxides with layered structure include, but are not limited to lithium cobalt oxide (LiCoO₂), lithium nickel oxide (LiNiO₂), a lithium nickel manganese cobalt oxide (e.g., Li(NiₓMn_{y}Co_{z})O₂), where 0≤x≤1, 0≤y≤1, 0≤z≤1, and x+y+z=1), a lithium nickel cobalt metal oxide (e.g., LiNi_{(1-x-y)}CoₓM_{y}O₂), where 0<x<1, 0<y<1 and M is Al, Mn). Other known lithium-transition metal compounds such as lithium iron phosphate (LiFePO₄) or lithium iron fluorophosphate (Li₂FePO₄F) can also be used. In certain aspects, the positive electrode 32 may include an electroactive material that includes manganese, such lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide. Additional examples of positive electrode active material include but are not limited to lithium nickel cobalt manganese oxide (NCM), lithium nickel cobalt aluminum oxide (NCA), lithium nickel cobalt manganese aluminum oxide (NCMA), or combinations thereof.

The binder for the positive electrode active material can increase the binding properties of positive electrode active material particles with one another and with the positive electrode current collector 42. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, carbon nanotubes, and the like.

Referring to FIGS. 3A-B, the negative active material layer 42 includes a negative active material, a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO, where z is from 0.09 to 2. Mixtures of carbon-based negative active materials, silicon-based negative active materials can also be used for the negative active material.

The negative electrode binder binds negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol, carboxymethyl cellulose, and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for forming a solid electrolyte interface on a lithium-ion battery electrode, the method comprising:
introducing a first quantity of a first electrolyte composition into a container, the container including at least one lithium-ion battery cell and the first electrolyte composition including ethylene carbonate;
cycling the lithium-ion battery cell for at least one charging cycle such that one or more solid electrolyte interfaces are formed; and
introducing a second electrolyte composition into the container to form a final electrolyte composition, the second electrolyte composition including propylene carbonate, wherein the first electrolyte composition, the second electrolyte composition, and the final electrolyte composition each independently include a lithium salt dissolved therein.

2. The method of claim 1 wherein the final electrolyte composition includes from about 20 to 99 weight percent propylene carbonate.

3. The method of claim 1 wherein the final electrolyte composition includes from about 50 to 99 weight percent propylene carbonate.

4. The method of claim 1 wherein the container is a pouch.

5. The method of claim 1 wherein the container is a metal can.

6. The method of claim 1 wherein the lithium-ion battery cell is degassed prior to introducing the second electrolyte composition.

7. The method of claim 1 wherein the lithium-ion battery cell is cycled for a plurality of cycles prior to introducing the second electrolyte composition.

8. The method of claim 1 wherein the lithium-ion battery cell is cycled for at least 2 cycles prior to introducing the second electrolyte composition.

9. The method of claim 1 wherein the first electrolyte composition includes a passivating additive.

10. The method of claim 9, wherein the passivating additive is vinylene carbonate (VC), vinyl ethylene carbonate (VEC), or a sulfone.

11. The method of claim 1, wherein the lithium-ion battery cell includes a negative electrode that includes a graphite layer.

12. The method of claim 11, wherein a solid electrolyte interface forms on the negative electrode thereby protecting the graphite layer from propylene carbonate co-intercalation.

13. The method of claim 1, wherein the first electrolyte composition further includes a first additional solvent selected from the group consisting of dimethyl carbonate, diethyl carbonate, dipropyl carbonate, methylpropyl carbonate, ethylpropyl carbonate, ethylmethyl carbonate, butylene carbonate, and combinations thereof.

14. The method of claim 1, wherein the first additional solvent is present in an amount less than an amount of the ethylene carbonate.

15. The method of claim 1, wherein the second electrolyte composition further includes a second additional solvent selected from the group consisting of includes dimethyl carbonate, diethyl carbonate, dipropyl carbonate, methylpropyl carbonate, ethylpropyl carbonate, ethylmethyl carbonate, butylene carbonate, and combinations thereof.

16. The method of claim 1, wherein the second additional solvent is present in an amount less than an amount of the propylene carbonate.
